(19) United States
(12) Patent Application Publication
(10) Pub. No.: US 2011/0310405 A1
(43) Pub. Date: Dec. 22, 2011

(54) PRINTING EMAIL MESSAGES

(76) Inventor: Petar KRAGULJAC, Broadview Heights, OH (US)

(21) Appl. No.: 13/159,587

(22) Filed: Jun. 14, 2011

Related U.S. Application Data
(60) Provisional application No. 61/356,278, filed on Jun. 18, 2010.

(51) Int. Cl. G06K 15/02

(52) U.S. Cl. 358/1.6

(57) ABSTRACT

Systems, methods, and other embodiments associated with printing content are described. One embodiment includes a method that provides an option that prints only the first page of content.

### CROSS REFERENCE TO RELATED APPLICATIONS

This application claims the benefit of U.S. provisional patent application Ser. No. 61/356,278 filed on Jun. 18, 2010, which is hereby wholly incorporated by reference.

### BACKGROUND

When using a computer system to process documents, a user will at some time wish to print the document. In Microsoft® applications, the user would have to select the “Office Button” that opens a list of functions in an expanded menu window. In the list, the user would find and select a print option. When the print option is selected, a printer driver application opens a printer driver window that shows additional options for printing. The user then must select more options to identify what is to be printed and how it is to be printed. When finished with the printing options, the user would select the “OK” button or “print” button to actually begin printing. For a word processing document, limited printing options are available such as a page range where the user is required to identify the page range to be printed.

In typical email processing applications, a page range option is not available and a current page print option does not exist. One possible reason is that email messages are not organized in pages and do not have the notion of pages. Rather, email messages are continuous exchanges of correspondence and do not have page numbers.

There are instances when a user may wish to print only the first page of a long email exchange. There are round-about-ways of printing the first page but they require many steps and knowledge of computer tricks. For example, selecting and copying a block of text from the email message, opening a new word processing document, pasting the copied text in the document and printing the document, which by default prints “all” pages. If the user, by chance, selected less than one page of content, then only one page is printed because there are no other pages. This process is inefficient. More often than not, the user prints all pages of the email message and throws away printed pages 2, 3, and so on. This process needlessly consumes resources like paper and ink.

### BRIEF SUMMARY

In one embodiment, a system is provided for displaying a first page print option on a display screen, which when activated, causes only a first page from a multipage document to be printed.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of a first page printing logic that may operate in an example email application.

FIG. 2 illustrates one embodiment of a method associated with printing a first page of a multipage document.

### DETAILED DESCRIPTION

Systems and methods are described herein that provide a feature of printing the first page of a document. For example, the first page of an email message is printed upon selecting an option and any other pages are not printed. Thus only the first page is printed while the system does not print pages subsequent to the first page. In one embodiment, the system prints the first page of a multipage document without requiring a user to input or identify a page range; or without the user identifying a current page option.

A typical email message includes correspondence exchanges (e.g. reply messages) between multiple people. The exchanges create a string or chain of email messages that appear on each person's email account. After each new email message is received, a user might print the email to have a hard copy of the most recent correspondence. However after a number of reply messages and print actions, duplicate messages and duplicate pages are printed over and over. In many instances, the user only wants the first page of the email correspondence and the other pages are thrown away. Thus many printed pages are wasted.

As an example, suppose a corporation has 50,000 employees and each employee prints only two emails per day. Suppose that each email has two pages but only the first page is needed. The second printed page gets thrown away. Thus 100,000 printed email pages are thrown away in one day, which amounts to 500,000 pages per week (in five days) and 2 million pages per month (based on 20 working days). At a cost of $0.02 per page, the wasted pages cost $40,000 per month or $480,000 per year. Most likely, many more emails are printed each day and more than one page gets thrown away per email. It is not unusual for an email message to contain content that extends over five or more printed pages.

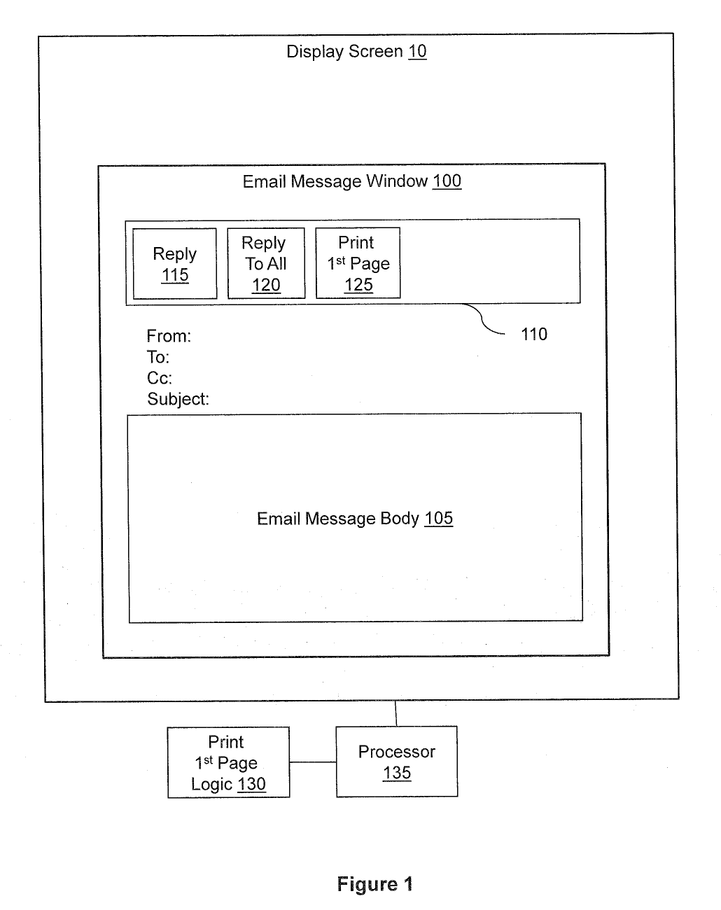

With reference to FIG. 1, one embodiment of a display 10 of a computing device is shown with an example email message window 100 that contains an email message body 105. Content of email correspondence is displayed in the email message body 105. In one embodiment, a tool bar 110 is displayed adjacent to the email message body 105. The tool bar 110 contains one or more icons or other menu options for performing actions. For example, a reply option 115 for replying to an email message, a “reply to all” option 120 for replying to all previous email recipients, and/or other options can be included. A print option 125 is displayed that is configured to print only the first page of the email message. Thus in some embodiments, one action (e.g. one click) can be taken by the user to automatically print only the first page of the email message body 105, which causes the printing function to automatically ignore subsequent pages.

In one embodiment, the system may be configured as follows. In response to the print 1^{st} page option 125 being selected, print 1^{st} page logic 130 is executed by at least a processor 135, which causes the one page to be automatically printed without requiring or requesting additional input selections from the user. Thus when the user is viewing the email message in the email message window 100 and the print 1^{st} page option 125 is selected, the print 1^{st} page logic 130 determines the content from the email message body 105 that will fit on one page, which may include the email header information (e.g. the fields From: (sender), To: (recipients), CC: (copied recipients), Subject:, and so on). Of course, other combinations of fields or other fields can be included in the header information, which can vary based on the email application used and/or properties that are set. The print 1^{st} page logic 130 then controls a printer driver or other applicable printing application to print the first page. The system is configured to print the first page without requiring or responding to additional input that designates a page range or designates a current page option.

In one embodiment, the print 1^{st} page logic 130 is configured to generate and send a print job to a default printer in response to selecting the print 1^{st} page option 125 without requesting more input from the user. In another example, the first page is automatically caused to be printed without opening and displaying additional new windows on the display screen (e.g. new windows that have data input fields).

In one embodiment, the email message body 105 and the print option 125 are displayed together in a common window on the display screen (e.g. in the same email message window 100). This provides easy access for printing the first page (e.g. one click, one page is printed) without opening additional windows.

In one embodiment, in response to the print option 125 being selected, the print 1^{st} page logic 130 determines the content to be printed on one page. This may include the email header information and a portion of content from the email message body 105 that starts with the most recent correspondence received in the email (e.g. based on date and time received). The correspondence of email messages are chained together in chronological order by date/time with the most recently received message appearing at the top of the chain. The content to be printed is limited to a length that fits on one printed page so only the first page of the most recent correspondence is printed.

The print 1^{st} page logic 130 generates instructions that cause a printing device to print the designated content. This may include communicating with a print driver or other interface that communicates with the printing device. The instructions cause the print driver or interface to print the first page on the associated printing device, for example, a default printer. In another embodiment, the instructions may be generated by logic from the print driver itself.

In one embodiment, logic associated with the print option 125 generates a print job that contains content from the email message associated with one printable page (e.g. that will fit on one 8 1/2 by 11 inch page or other default page size) from the first page in a sequence of possible pages. The remaining content from the email message (e.g. content that would be on sequential pages 2, 3, and so on) is intentionally not included and eliminated from the print job. Thus only the first page is printed. In one embodiment, the logic includes processor executable instructions stored on a non-transitory computer-readable medium configured to perform the described functions or their equivalents.

In one embodiment, automatically printing the first page may include opening and displaying a printer driver window in response to the print option 125 being selected. Printer driver settings are, however, preset to print only the first page of the email message or document. When the user clicks an “OK” or “Print” button to start printing, only the first page in the chain of content is printed. Content on pages 2 or more are ignored/eliminated from the print instructions.

In another embodiment, the printer driver window may be configured to include a stand-alone selectable option that represent a “print first page” function. This option can be included with other page printing options, for example, “page rage” option or print “all” option.

In another embodiment, the printer driver is pre-configured to restrict a user to print only the first page of an email message or other document (e.g. using pre-set settings or instructions). Thus when the print option 125 or a print “all” option from a file menu is selected to print an email message, the print driver is defaulted to a setting that prints only the first page. In one embodiment, the system restricts access to changing settings and thus a user cannot change the setting unless they have appropriate authorization. Such a setting may help the user and/or an organization to control wasteful printing of email messages or other documents by not printing pages two and beyond.

In one embodiment, an email processing application is implemented with logic for the first page print option 125 for printing the first page of an email message. The email processing application can be designed with the functions described herein or can be updated with new code or a plug-in program from a non-transitory computer-readable medium. The email processing application can be a web browser application (web-based email) that processes emails (e.g. gmail, Yahoo® mail, etc.), a dedicated email application (e.g. Microsoft® Inbox®), and so on.

In another embodiment, the print option 125 and associated logic are implemented on a computing device that includes at least one processor, a display screen, and memory. The computing device may include a desktop computer, a laptop computer, a mobile device, a cellular phone, a tablet computer, a smart phone, a personal digital assistant, and so on With the present system, resources such as paper and ink can be conserved by restricting the printing of email messages or other documents to only the first page.

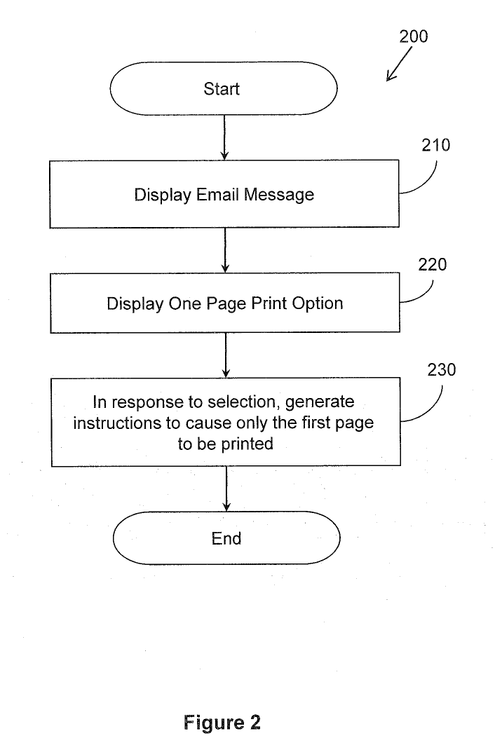

With reference to FIG. 2, one embodiment of a computer-implemented method 200 is illustrated. The method 200 can initiate when a user wishes to view an email message on a computing device. At 210, the email message (which may include a chain of correspondence) is displayed on a display screen. At 220, a one page print option is displayed on the display screen (e.g. a first page print option or icon). At 230, in response to the first page print option being selected, only the first page of the email message is printed and any other pages are automatically eliminated from the print process. For example, the email content starting with the most recently received correspondence is determined as the first page of content that will fit on one piece of paper. Thus if an email message contains content that spans five printed pages, only the first page (page 1) is printed and pages 2-5 are not included in the print job and/or the print.

In another embodiment, the first page print option is implemented in a web browser application for printing only the first page of a displayed web page. All other pages are not included in the print process and are not printed as described above. Similar to email messages, a displayed web page is continuous content with no notion of page numbers and typically spans multiple display screen pages with no page count or page number designations. But only the first page (e.g. the top of the content) may be desired for printing. How the displayed pages correspond to actual printed pages is not readily distinguishable to the user since the web content is not organized in pages. Thus printing only the first page simplifies the print process. In another embodiment, the first page print option is implemented in a word processing document to apply to other documents that are not emails or web pages.

With the disclosed printing system, the cost of operating printers can be reduced. By not printing unwanted or additional pages, paper is conserved, ink/toner is conserved, and wear on the printing device is reduced. This may result in cost savings for an organization.

While the figures illustrate various actions occurring in serial, it is to be appreciated that various actions could occur substantially in parallel and/or in other orders. While a certain number of processes are described, it is to be appreciated that a greater and/or lesser number of processes could be employed. Moreover, less than all the illustrated blocks may be used to implement an example methodology. Blocks may be combined or separated into multiple components. Furthermore, additional and/or alternative methodologies can employ additional, not illustrated blocks.

In some embodiments, the described methods and their equivalents may be implemented with computer or processor executable instructions. Thus, in one embodiment, a non-transitory computer-readable medium is configured with stored computer/processor executable instructions that if executed by a machine (e.g., processor, computer, mobile device, smart phone, and/or other associated components) cause the machine (and/or associated components) to perform the method.

“Logic”, as used herein, includes but is not limited to hardware, firmware, instructions stored in a non-transitory computer-readable medium, instructions in execution on a machine, and/or combinations of each to perform a function(s) or an action(s), and/or to cause a function or action from another logic, method, and/or system. Logic may include a microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple logics. One or more of the described features or their equivalents may be implemented with one or more logic elements.

While example systems, methods, and so on have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A computer-implemented method comprising:
displaying an email message in a window on a display screen;
displaying a print option in the window on the display screen where the print option is associated with functions for automatically printing only a first page from the email message; and
in response to the print option being selected, generating instructions that cause only the first page of the email message to be printed by a printing device.

2. The method of claim 1, where the first page of the email message is automatically printed when the print option is selected without requiring an input from a current page option or an input from a page range.

3. The method of claim 1, where in response to the print option being selected, the first page is automatically caused to be printed without requesting additional input selections from a user.

4. The method of claim 1, where in response to the print option being selected, the first page is automatically caused to be printed without opening additional windows on the display screen.

5. The method of claim 1, where the email message and the print option are displayed together in a common window on the display screen.

6. The method of claim 1, further including determining the first page from correspondence in the email message that is most recently received content.

7. A non-transitory computer-readable medium that stores executable instructions that when executed by a device, cause the device to perform a method, the method comprising:
displaying an email message on a display screen;
displaying a first page print option on the display screen; and
automatically causing only the first page from the email message to be printed when the first page print option is selected.

8. The non-transitory computer-readable medium of claim 7, where the email message includes correspondence organized in a most-recently received chronological order; and
where the non-transitory computer-readable medium further includes instructions that determine the first page from the correspondence in the email message that is most recently received and that determine an amount of correspondence that prints on one hardcopy page.

9. The non-transitory computer-readable medium of claim 7 where in response to the print option being selected, the first page is automatically caused to be printed without requesting additional input selections from a user.

10. The non-transitory computer-readable medium of claim 7 where in response to the print option being selected, the first page is automatically caused to be printed without opening additional windows on the display screen.

11. The non-transitory computer-readable medium of claim 7 where the email message and the print option are displayed in the same window on the display screen.

12. The non-transitory computer-readable medium of claim 7 further comprising an email processing program that includes the first page print option for printing the first page of the email message.

13. A non-transitory computer-readable medium that stores executable instructions that when executed by a computing device, cause the computing device to perform a method, the method comprising:
displaying a first page print option on a display screen, which when activated, causes only a first page from a multipage document to be printed while ignoring content from subsequent pages.

14. The non-transitory computer-readable medium of claim 13, where printing the first page includes not printing pages subsequent to the first page.

15. The non-transitory computer-readable medium of claim 13, where the first page of the multipage document is automatically printed when the first page print option is selected without requiring an input from a current page option or an input from a page range option.

16. The non-transitory computer-readable medium of claim 13, where the multipage document is an email message that includes correspondence organized in a most-recently received chronological order; and
where the non-transitory computer-readable medium further includes instructions that determine the first page from the correspondence in the email message that is most recently received and determine an amount of correspondence that prints on one hardcopy page.
